(19) United States
(12) Patent Application Publication
(10) Pub. No.: US 2025/0356650 A1
(43) Pub. Date: Nov. 20, 2025

(54) LANDSLIDE IDENTIFICATION METHOD, DEVICE, AND STORAGE MEDIUM BASED ON MULTI-PATH FEATURE FUSION

(71) Applicant: China University of Geosciences, Wuhan, Wuhan (CN)

(72) Inventors: Jie Dou, Wuhan (CN); Aonan Dong, Wuhan (CN); Songcheng Zhang, Wuhan (CN); Yonghu Fu, Wuhan (CN); Hao Li, Wuhan (CN); Yigui Peng, Wuhan (CN)

(73) Assignee: China University of Geosciences, Wuhan, Wuhan, HB (CN)

(21) Appl. No.: 19/278,769

(22) Filed: Jul. 23, 2025

(30) Foreign Application Priority Data
Jul. 25, 2024 (CN) 202411006142.9

(51) Int. Cl. G06V 20/10; G06V 10/80; G06V 10/82

(52) U.S. Cl. CPC G06V 20/10; G06V 10/806; G06V 10/82

(57) ABSTRACT

The present disclosure provides a landslide identification method, a device and a storage medium based on multi-path feature fusion, and relates to the field of geological hazard monitoring and early warning. The device and storage medium are used to implement the method. The beneficial effects of the present disclosure are as follows: a landslide identification method based on multi-path is provided, deep feature-level interaction among different types of landslide image data is achieved, high-resolution feature information is preserved, landslide identification accuracy is significantly improved, the computational costs are reduced, the real-time performance of landslide identification is significantly enhanced and the real-time monitoring and early warning are achieved.

### TECHNICAL FIELD

The present disclosure relates to the field of geological hazard monitoring and early warning, particularly to a landslide identification method, a device and a storage medium based on multi-path feature fusion.

### BACKGROUND

With the development of science and technology, modern geological hazard monitoring methods have gradually introduced advanced technical means, including remote sensing technology, sensor networks and big data analysis. These methods have achieved significant progress in improving monitoring efficiency and early warning accuracy.

Remote sensing technologies: large-scale areas can be monitored by utilizing satellite imagery and unmanned aerial vehicles (UAVs) technology. Remote sensing technology can provide high-resolution surface images to help identify early signs of geological hazards. Limitations: low acquisition frequency of remote sensing data makes the real-time monitoring difficult; complex data processing requires substantial computational resources.

Sensor networks: sensors such as rain gauges, displacement meters, and groundwater level gauges are deployed in geological hazard-prone areas to monitor environmental parameter changes in real time. Limitations: high deployment costs and maintenance difficulties for sensors; single-sensor data is prone to noise interference, affecting the early warning accuracy.

Big data analysis: geological hazard risk assessment models are constructed by collecting and analyzing large amounts of historical data, so as to enhance the scientific validity and accuracy of early warnings. Limitations: model training relies on extensive high-quality data, which is difficult to acquire; complex models have high computational costs and exhibit poor real-time performance.

Conventional single encoder network architecture: in the field of geological hazard monitoring, conventional landslide identification methods typically adopt a single encoder network architecture. These methods rely on classical deep learning and machine learning models such as U-Net, fully convolutional networks (FCN), deepLabV3, multilayer perceptron (MLP), support vector machine (SVM), and artificial neural network (ANN). These conventional models play an important role in landslide identification, but also have certain limitations. Limitations: models with conventional single encoder network architectures may have difficulty adapting to new environments or geological conditions after being trained on specific data sets; due to the high computational complexity of the models, their real-time processing capability is weak, making it difficult to respond quickly to sudden landslide hazards.

### SUMMARY

The purpose of the present disclosure is: in order to overcome the shortcomings of multi-source data fusion, high computational cost and poor real-time performance of conventional single encoder network architecture in landslide intelligent identification, the present disclosure provides a landslide identification method, a device and a storage medium based on multi-path feature fusion. A landslide identification method based on multi-path feature fusion, mainly including the following steps:

S1, acquiring a landslide image data set and performing preprocessing;

S2, dividing a data set;

S3, constructing a multi-path landslide identification model fusing dual-attention mechanisms;

S4, training the multi-path landslide identification model by using the data set, and outputting the multi-path landslide identification model after completion of training; and

S5, inputting landslide image data to be identified into the trained multi-path landslide identification model, and outputting a landslide identification result.

Further, the multi-path landslide identification model includes a main encoder module and a sub encoder module containing stacked encoders, and a decoder module containing stacked decoders, wherein both the composition structures of the encoder and decoder introduce a convolutional block attention mechanism module.

Further including, the main encoder module and sub encoder module are interconnected via a feature-aware self-attention mechanism gate, and are connected to the decoder module through a deepest encoder layer and skip connections.

Further, the landslide image data set includes landslide images and corresponding topographic factor images, and the preprocessing steps include: performing image enhancement and normalization on the landslide images and topographic factor images, respectively, followed by pairwise matching and binding.

Further, the convolutional block attention mechanism module is a sequential integration of channel attention and spatial attention mechanisms, with its mathematical representation as follows:

$${F}^{′} = {M}_{c} ( F ) e F$$

$${F}^{″} = {M}_{s} ( {F}^{′} ) e {F}^{′}$$

where, F represents an input feature map of the convolutional block attention mechanism module, F′ and F″ represent an integration result of the channel and the spatial attention mechanism, respectively, and F″ also represents an output feature map of the convolutional block attention mechanism module; M_{c}(·) and Mₛ(·) represent channel and spatial attention functions, respectively; e represents an element-by-element multiplication.

Further, the main encoder module and the sub encoder module process the landslide images and topographic factor images, respectively, the input image passes through a 1×1 convolution and is then encoded by stacked encoders, with the main encoder module containing one more encoder than the sub encoder module.

The decoder module adopts the decoder architecture of the U-Net model, containing a same number of stacked decoders as the encoders in the main encoder module, the encoding result from the deepest encoder layer of the main encoder module is decoded, and finally, a landslide identification result map is output through upsampling and convolution operations.

Further, the encoder structure sequentially consists of a residual connection block, a convolutional block attention mechanism module, and a convolution module.

Further, the decoder structure sequentially consists of an upsampling module, a concatenation module, a residual structure module, and a convolutional block attention mechanism module.

Further, the feature-aware self-attention mechanism gate fuses the encoded feature map from the encoder layer in the sub encoder module with the encoded feature map from the corresponding encoder layer in the main encoder module;

the specific working process is as follows: generating a query matrix and a value matrix from the output feature map of the encoder layer in the main encoder module through the 1×1 convolution layer, and generating a key matrix from the output feature map of the encoder layer in the sub encoder module, then calculating self-attention weighted features, finally, fusing the weighted features with the output feature map from the encoder in the main encoder module to obtain a self-attention-adjusted feature map, configuring the self-attention-adjusted feature map as the input for the next encoder layer in the main encoder module.

Further, the skip connection is achieved by an atrous spatial pyramid pooling (ASPP) module, the two ends are connected to the output of the encoder in the main encoder module and the concatenation module of the decoder at the same level in the decoder module, respectively, and the output of each encoder layer is retained and transmitted to the decoder layer of the same layer.

The formula of the working process of the ASPP module is expressed as follows:

$$Y = {\sum }_{i = 1}^{N} {W}_{i} * {F}_{{d}_{i}} ( X )$$

where X is the input feature map, F_{d}_{ᵢ} represents a dilated convolution operation with an expansion rate of dᵢ, Wᵢ is a corresponding weight, * represents a convolution operation, and N is a number of types of dilated convolution.

Further, step S4 specifically includes:

S41, setting an iteration cycle and a maximum number of training epochs;

S42, selecting landslide images and corresponding topographic factor images from a training set, inputting the landslide images and corresponding topographic factor images into the main encoder module and the sub encoder module of the multi-path landslide identification model, respectively, and outputting the identification result map through the decoder;

S43, calculating a loss function of the model, specifically a weighted combination of a cross-entropy loss function and a Dice loss function, and optimizing model parameters through a backpropagation and a gradient descent;

S44, repeating steps S42-S43, retaining the model once upon completing one iteration cycle, inputting validation set data into the updated model, and evaluating model performance; and

S45, terminating training upon reaching a maximum number of training epochs, and selecting the model output with the optimal performance as the trained multi-path landslide identification model.

A storage medium, the storage medium stores instructions and data for implementing the landslide identification method based on multi-path feature fusion.

A computer device, including: a processor and a storage medium; wherein the processor loads and executes the instructions and data in the storage medium to implement the landslide identification method based on multi-path feature fusion.

The beneficial effects of the technical solution provided by the present disclosure are as follows: the present disclosure provides a landslide identification method based on multi-path feature fusion, which includes multi-path encoder modules and introduces a dual-attention mechanism to achieve deep feature-level interaction among different types of landslide image data. Additionally, the encoder and decoder modules are connected via skip connections to preserve high-resolution feature information, significantly improving landslide identification accuracy. The parallel operation of the multi-path encoder module reduces computational costs, while the U-Net selected for the decoder module enables rapid decoding, significantly enhancing the real-time performance of landslide identification and achieving real-time monitoring and early warning.

### BRIEF DESCRIPTION OF THE DRAWINGS

The following is a further description of the present disclosure with reference to the accompanying drawings and embodiments. In the accompanying drawings:

FIG. 1 is a flowchart of a landslide identification method based on multi-path feature fusion according to an embodiment of the present disclosure;

FIG. 2 is a schematic diagram of a network structure of a multi-path landslide identification model according to an embodiment of the present disclosure;

FIG. 3 is a schematic structural diagram of a convolutional block attention module according to an embodiment of the present disclosure;

FIG. 4 is a schematic structural diagram of a residual structure block according to an embodiment of the present disclosure;

FIG. 5 is a schematic structural diagram of a feature-aware self-attention mechanism gate according to an embodiment of the present disclosure;

FIG. 6 is a schematic structural diagram of an ASPP module according to an embodiment of the present disclosure;

FIG. 7 is a schematic diagram of landslide identification effects of various models in comparative experiments according to an embodiment of the present disclosure;

FIG. 8 is a schematic diagram of hardware device operation according to an embodiment of the present disclosure.

### DETAILED DESCRIPTION OF THE EMBODIMENTS

In order to make the technical features, objectives, and effects of the present disclosure clearer, the specific embodiment of the present disclosure will now be described in detail with reference to the accompanying drawings.

The embodiment of the present disclosure provides a landslide identification method, a device and a storage medium based on multi-path feature fusion.

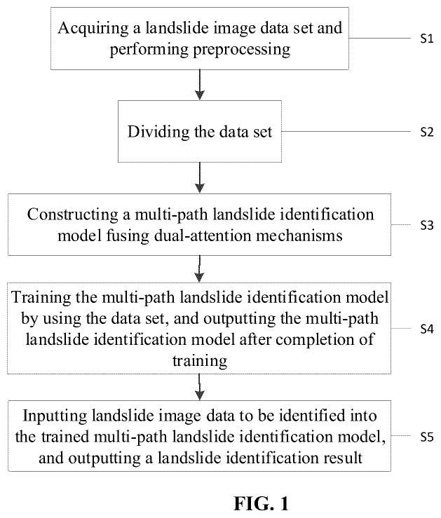

With reference to FIG. 1, FIG. 1 is the flowchart of the landslide identification method based on multi-path feature fusion according to an embodiment of the present disclosure, specifically including the following steps:

Step 1, the landslide image data set is acquired and preprocessing is performed.

The landslide image data set includes landslide images and corresponding topographic factor images, and the preprocessing steps include: image enhancement and normalization are performed on the landslide images and corresponding topographic factor images, respectively, followed by pairwise matching and binding.

Step 2, the data set is divided.

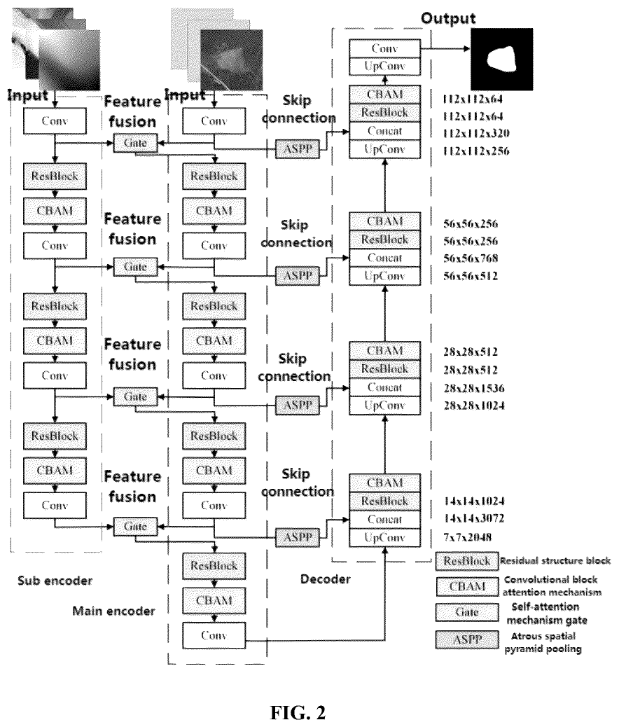

Step 3, the multi-path landslide identification model fusing dual-attention mechanisms is constructed, as shown in FIG. 2, as follows:

including: the main encoder module and the sub encoder module containing stacked encoders, and the decoder module containing stacked decoders, wherein both the composition structures of the encoder and decoder introduce the convolutional block attention mechanism module.

The main encoder module and the sub encoder module process the landslide images and topographic factor images, respectively, the input image passes through a 1×1 convolution and is then encoded by stacked encoders, with the main encoder module containing one more encoder than the sub encoder module.

The decoder module adopts the decoder architecture of the U-Net model, containing the same number of stacked decoders as the encoders in the main encoder module, the encoding result from the deepest encoder layer of the main encoder module is decoded, and finally, the landslide identification result map is output through upsampling and convolution operations.

The encoder structure sequentially consists of the residual connection block, the convolutional block attention mechanism module, and the convolution module; the decoder structure sequentially consists of the upsampling module, the concatenation module, the residual structure module, and the convolutional block attention mechanism module.

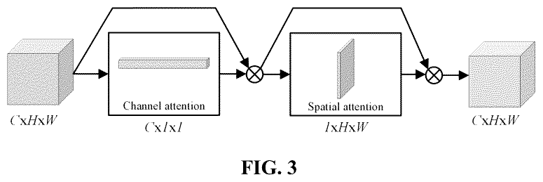

In the encoding and decoding stages, the convolutional block attention module (CBAM) is introduced. The specific structure is shown in FIG. 3. The feature map is processed by channel attention and spatial attention to enhance the expression ability of important features. The convolutional block attention mechanism module is the sequential integration of channel attention and spatial attention mechanisms, the specific steps are as follows:

Channel attention: global average pooling and global max pooling are performed on the input feature maps to obtain two different feature maps, the feature maps are processed through the shared fully connected layer and weighted at the element level.

Spatial attention: the max pooling and average pooling of the channel dimension are performed on the input feature maps to obtain two different feature maps, the feature maps are processed by the convolution layer and weighted at the element level.

The mathematical representation of the process is as follows:

$${F}^{′} = {M}_{c} ( F ) e F$$

$${F}^{″} = {M}_{s} ( {F}^{′} ) e {F}^{′}$$

where, F represents the input feature map of the convolutional block attention mechanism module, F′ and F″ represent the integration result of the channel and the spatial attention mechanism, respectively, and F″ also represents an output feature map of the convolutional block attention mechanism module; M_{c}(·) and Mₛ(·) represent channel and spatial attention functions, respectively; e represents the element-by-element multiplication.

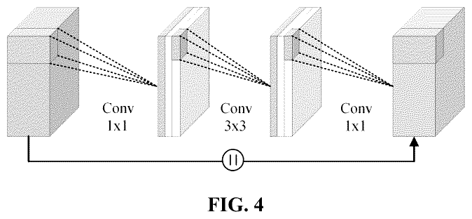

Residual block is introduced into the encoder and decoder layers by using the residual connection technology, the structure is shown in FIG. 4. This connection method can effectively alleviate the problem of gradient disappearance in deep neural networks, while retaining high-resolution feature information.

The wide application of the model aims to solve the problem of gradient disappearance in deep networks and improve the performance of landslide identification. Through the residual connection, the input features are directly transmitted to the subsequent layers, which simplifies the training and strengthens the feature propagation (FIG. 3). For each residual structure block, the output is defined by the following formula:

H(x)=F(x)+x

wherein, H(x) represents the output of the residual structure block; x represents the input features, and F(x) represents the weighted operation and nonlinear activation function in the residual block. This structure enables the network to learn the residual mapping between input and output, which helps to capture subtle feature changes in landslide identification, thereby improving the identification accuracy.

Further including, the main encoder module and sub encoder module are interconnected via the feature-aware self-attention mechanism gate, and are connected to the decoder module through the deepest encoder layer and skip connections. The present disclosure achieves the dual-attention mechanism through the feature-aware self-attention mechanism gate and the convolutional block attention mechanism module.

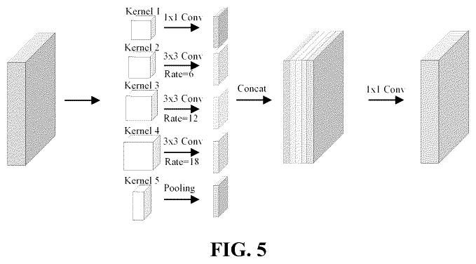

The structure of the feature-aware self-attention mechanism gate is shown in FIG. 5. The coding feature map is fused with the coding feature map of the encoder of the same layer in the main encoder module. The specific working process is as follows: the query matrix and the value matrix are generated from the output feature map of the encoder layer in the main encoder module through the 1×1 convolution layer, and the key matrix is generated from the output feature map of the encoder layer in the sub encoder module, then the self-attention weighted features are calculated. Firstly, the similarity between the query matrix (Q) and the key matrix (K) is calculated by matrix multiplication to obtain the attention score. Secondly, the obtained score matrix is standardized and converted into an attention weight by the sigmoid function. Finally, the attention weight and the value matrix (V) are weighted and summed to obtain the weighted features; the mathematical expression of self-attention weight is:

$$Attention\_weight ( Q , K , V ) = sigmoid ( \frac{{QK}^{T}}{\sqrt{{d}_{k}}} ) V$$

where, Attention_weight( ) represents the self-attention weight function; sigmoid is the activation function; dₖ is the dimension of the key matrix, \sqrt{dₖ} is used to scale the dot product to prevent the gradient from being too small.

The weighted feature is fused with the output feature map of the encoder in the main encoder module to obtain the feature map with self-attention adjustment, the feature map with self-attention adjustment as input of the next encoder in the main encoder module. The feature map output by the self-attention mechanism contains rich context information, which significantly improves the sensitivity of the model to landslide features (such as terrain changes, vegetation cover differences, etc.). This allows the model to focus on key features and learn in depth the advanced representation of landslides.

The skip connection is achieved by the ASPP module, and the two ends are connected to the output of the encoder in the main encoder module and the concatenation module of the decoder at the same level in the decoder module, respectively.

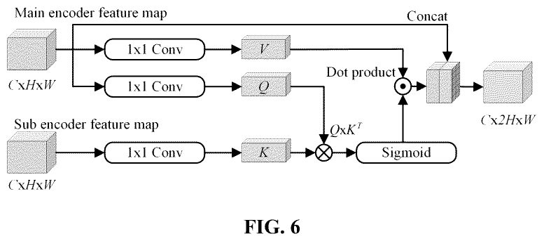

The structure of the ASPP module is shown in FIG. 6, which effectively captures the landslide features at different scales by using cavity convolutions with different expansion rates. It can provide a larger receptive field without increasing the computational cost, so as to capture more extensive context information and enhance the adaptability of the model to complex environments.

The formula of the working process of the ASPP module is expressed as follows:

$$Y = {\sum }_{i = 1}^{N} {W}_{i} * {F}_{{d}_{i}} ( X )$$

where X is the input feature map, F_{d}_{ᵢ} represents the dilated convolution operation with an expansion rate of dᵢ, Wᵢ is the corresponding weight, * represents the convolution operation, and N is the number of types of dilated convolution.

Step 4, the multi-path landslide identification model is trained by using the data set, and the multi-path landslide identification model is output after the completion of training, as follows:

Step 41, the iteration cycle and the maximum number of training epochs are set;

Step 42, the landslide images and corresponding topographic factor images are selected from the training set, the landslide images and corresponding topographic factor images are input into the main encoder module and the sub encoder module of the multi-path landslide identification model, respectively, and the identification result map is output through the decoder;

Step 43, the loss function of the model is calculated, specifically the weighted combination of the cross-entropy loss function and the Dice loss function, and the model parameters are optimized through backpropagation and gradient descent;

Step 44, steps S42-S43 are repeated, the model is retained once upon completed one iteration cycle, the validation set data is input into the updated model, and the model performance is evaluated;

Step 45, the training is terminated upon reaching the maximum number of training epochs, and the model output with the optimal performance is selected as the trained multi-path landslide identification model.

Step 5, the landslide image data to be identified is input into the trained multi-path landslide identification model, and the landslide identification result is output.

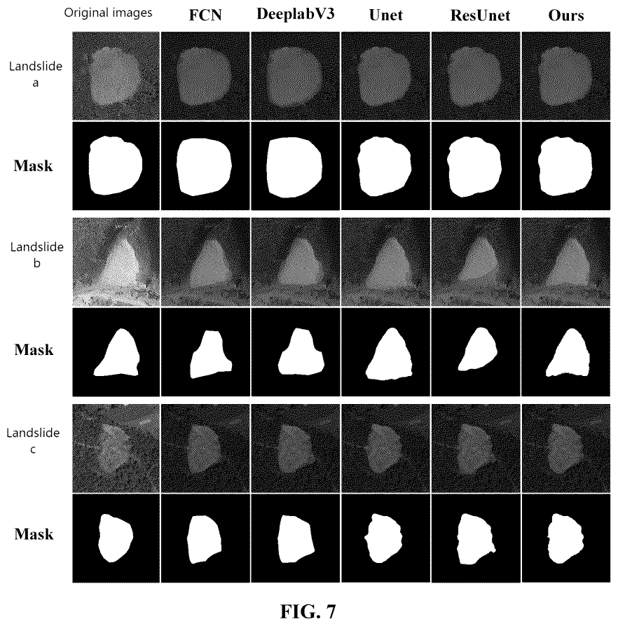

In order to verify the performance of the proposed multi-path feature fusion neural network in landslide identification, four classical semantic segmentation models are selected as comparison objects, including FCN, DeeplabV3, Unet and ResUnet. All models are trained on the same training data set and evaluated on the same test data set. The training data set includes a variety of landslide samples to ensure that the model can learn the different types of landslide features. The test data set contains a variety of actual landslide scenarios to evaluate the performance of the model in real applications. The specific landslide identification effect of each model is shown in FIG. 7. The accuracy of the identification results is summarized in Table 1, where three typical landslide images (denoted as a, b, and c, respectively) in the test set are selected for detailed comparison.

This comparative analysis reveals the significant advantages of multi-path feature fusion neural networks in accurate landslide identification compared with FCN, DeeplabV3, Unet and ResUnet models. Specifically, other models have certain limitations in accurately identifying landslide areas, which are manifested in the phenomenon of misclassification and omission of landslide areas.

By comprehensively comparing the performance of these five models on multiple accuracy indicators, it can be clearly seen that the multi-path feature fusion neural network not only has obvious advantages in the accuracy of identifying landslide areas, but also performs well in terms of comprehensiveness and consistency of landslide capturing.

TABLE 1
Comparison of identification results of different network models

| | | | | Mean |
|---|---|---|---|---|
| | | | | intersection |
| Model | Precision | Recall | F1 score | over union |
| FCN | 0.848 | 0.660 | 0.742 | 0.782 |
| DeeplabV3 | 0.817 | 0.685 | 0.745 | 0.784 |
| Unet | 0.800 | 0.783 | 0.792 | 0.816 |
| ResUnet | 0.826 | 0.778 | 0.802 | 0.823 |
| Ours | 0.866 | 0.831 | 0.848 | 0.860 |

Verification of dual-coding path effect:

in order to further verify the effectiveness of the multi-path feature fusion neural network, four sets of experiments are designed and verified with different input samples. The first group of experiments merely used optical remote sensing images as input, and the results show that the precision is 0.856, but the recall is low, which is 0.778. The second group of experiments merely used the topographic factor image as input. The results show that the precision and recall of this method are 0.602 and 0.553, respectively, and it is almost impossible to effectively identify landslides. In the third group of experiments, the optical remote sensing image and the topographic factor image are merged and input into the main encoder, and the results show that the precision is 0.848 and the recall is 0.790. Although it has been improved, it has not yet reached the optimal. Finally, the fourth group of experiments used optical remote sensing images and topographic factor images to input the main encoder and the sub encoder, respectively. The results show that the precision, recall, F1 score and mean intersection over union all reached 0.866,0.831,0.848 and 0.860. These results verify the significant advantages of the multi-path input sample method in the landslide identification task, indicating that the model can better comprehensively utilize information from different sources and improve the accuracy and comprehensiveness of identification.

TABLE 2
Comparison of results of different input sample methods

| | | | | Mean |
|---|---|---|---|---|
| Input sample | | | | intersection |
| method | Precision | Recall | F1 score | over union |
| Single path | 0.856 | 0.778 | 0.815 | 0.834 |
| (only optical | | | | |
| image) | | | | |
| Single path | 0.602 | 0.553 | 0.576 | 0.680 |
| (only | | | | |
| topographic | | | | |
| factor) | | | | |
| Single path | 0.848 | 0.790 | 0.818 | 0.836 |
| (optical | | | | |
| image + | | | | |
| topographic | | | | |
| factor) | | | | |
| Multipath | 0.866 | 0.831 | 0.848 | 0.860 |

Verification of dual-attention mechanism ablation:

In order to verify the influence of the attention mechanism on the performance of the model, ablation experiments are performed to test the effects of the CBAM and the feature-aware self-attention gate. The results show that the addition of CBAM increases the precision of the model from 0.857 to 0.864, the recall from 0.805 to 0.811, the F1 score and the mean intersection over union increase to 0.837 and 0.851, respectively. After the introduction of self-attention gate, the recall of the model is significantly increased to 0.827, while the precision and F1 score are also increased to 0.853 and 0.840, respectively. When the two attention mechanisms are applied at the same time, all the evaluation indicators of the model are optimal, and the precision, recall, F1 score and mean intersection over union are 0.866,0.831,0.848 and 0.860, respectively. These results show that the CBAM and the feature-aware self-attention gate play an important role in improving the performance of the model, which can help the model capture the features of the landslide area more effectively and improve the identification accuracy and comprehensiveness.

TABLE 3
Experimental results of attention mechanism ablation

| | | | | | Mean |
|---|---|---|---|---|---|
| | Self-attention | | | | intersection |
| CBAM | Gate | Precision | Recall | F1 score | over union |
| x | x | 0.857 | 0.805 | 0.830 | 0.847 |
| ✓ | x | 0.864 | 0.811 | 0.837 | 0.851 |
| x | ✓ | 0.853 | 0.827 | 0.840 | 0.853 |
| ✓ | ✓ | 0.866 | 0.831 | 0.848 | 0.860 |

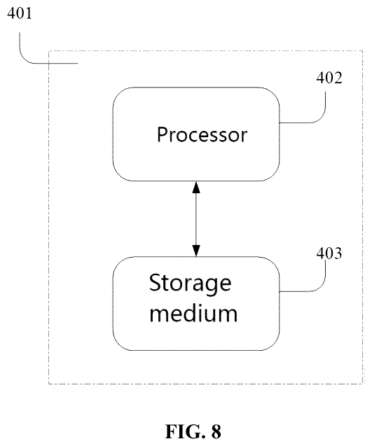

With reference to FIG. 8, FIG. 8 is a schematic diagram of hardware device operation of the embodiment of the present disclosure, the hardware device specifically includes: a computer device 401, a processor 402, and a storage medium 403.

A computer device 401: the computer device 401 implements the landslide identification method based on multi-path feature fusion.

Processor 402: the processor 402 loads and executes the instructions and data in the storage medium 403 to implement the landslide identification method based on multi-path feature fusion.

Storage medium 403: the storage medium 403 stores instructions and data; the storage medium 403 is used for implementing the landslide identification method based on multi-path feature fusion.

The beneficial effects of the present disclosure are as follows: the present disclosure provides a landslide identification method based on multi-path feature fusion, which includes multi-path encoder modules and introduces a dual-attention mechanism to achieve deep feature-level interaction among different types of landslide image data. Additionally, the encoder and decoder modules are connected via skip connections to preserve high-resolution feature information, significantly improving landslide identification accuracy. The parallel operation of the multi-path encoder module reduces computational costs, while the U-Net selected for the decoder module enables rapid decoding, significantly enhancing the real-time performance of landslide identification and achieving real-time monitoring and early warning.

Finally, it should be noted that the above embodiments are merely used for describing the technical solutions of the present disclosure, rather than limiting the same. Although the present disclosure has been described in detail with reference to the preferred examples, those of ordinary skill in the art should understand that it is still possible to modify the technical solutions described in the aforementioned embodiments or to replace some of the technical features with equivalent ones. However, these modifications or substitutions should not make the modified technical solutions deviate from the spirit and scope of the technical solutions of the present disclosure.

What is claimed is:

1. A landslide identification method based on multi-path feature fusion, wherein the specific steps comprise:
S1, acquiring a landslide image data set and performing preprocessing;
S2, dividing the data set;
S3, constructing a multi-path landslide identification model integrating dual-attention mechanism is constructed as follows:
combining a main encoder module and a sub encoder module containing stacked encoders, and a decoder module containing stacked decoders, wherein both composition structures of the encoder and decoder introduce a convolutional block attention mechanism module;
wherein, the main encoder module and sub encoder module are interconnected via a feature-aware self-attention mechanism gate, and are connected to the decoder module through a deepest encoder layer and skip connections;
S4, training the multi-path landslide identification model by using the data set, and outputting the multi-path landslide identification model after completion of training; and
S5, inputting landslide image data to be identified into the trained multi-path landslide identification model, and outputting a landslide identification result;
wherein the main encoder module and the sub encoder module process the landslide images and topographic factor images, respectively, wherein the input image passes through a 1×1 convolution and is then encoded by the stacked encoders, with the main encoder module containing one more encoder than the sub encoder module;
wherein the decoder module adopts the decoder architecture of the U-Net model, comprising a same number of stacked decoders as the encoders in the main encoder module, wherein the encoding result from the deepest encoder layer of the main encoder module is decoded level by level, and finally, wherein a landslide identification result map is output through upsampling and convolution operations;
wherein the encoder structure sequentially consists of a residual connection block, a convolutional block attention mechanism module, and a convolution module;
wherein the decoder structure sequentially consists of an upsampling module, a concatenation module, a residual structure module, and a convolutional block attention mechanism module;
wherein the feature-aware self-attention mechanism gate fuses the encoded feature map from the encoder layer in the sub encoder module with the encoded feature map from the corresponding encoder layer in the main encoder module;
wherein the specific working process comprises: generating a query matrix and a value matrix from the output feature map of the encoder layer in the main encoder module through the 1×1 convolution layer, and generating a key matrix from the output feature map of the encoder layer in the sub encoder module, then calculating self-attention weighted features, fusing the weighted features with the output feature map from the encoder in the main encoder module to obtain a self-attention-adjusted feature map, and configuring the self-attention-adjusted feature map as the input for the next encoder layer in the main encoder module;
wherein the skip connection is achieved by an atrous spatial pyramid pooling (ASPP) module, the two ends are connected to the output of the encoder in the main encoder module and the concatenation module of the decoder at the same level in the decoder module, respectively, and the output of each encoder layer is retained and transmitted to the decoder layer of the same layer;
wherein the formula of the working process of the ASPP module is expressed as follows:
$$Y = {\sum }_{i = 1}^{N} {W}_{i} * {F}_{{d}_{i}} ( X )$$
where X is the input feature map, F_{d}_{ᵢ} represents a dilated convolution operation with an expansion rate of dᵢ, Wᵢ is a corresponding weight, * represents a convolution operation, and N is a number of types of dilated convolution.

2. The landslide identification method based on multi-path feature fusion according to claim 1, wherein the landslide image data set comprises landslide images and corresponding topographic factor images, and the preprocessing steps comprise:
performing image enhancement and normalization on the landslide images and corresponding topographic factor images, respectively, followed by pairwise matching and binding.

3. The landslide identification method based on multi-path feature fusion according to claim 1, wherein the convolutional block attention mechanism module is a sequential integration of channel attention and spatial attention mechanisms, with its mathematical representation as follows:
$${F}^{′} = {M}_{c} ( F ) ⊙ F$$
$${F}^{″} = {M}_{s} ( {F}^{′} ) ⊙ {F}^{′}$$
where, F represents an input feature map of the convolutional block attention mechanism module, F′ and F″ represent an integration result of the channel and the spatial attention mechanism, respectively, and F″ also represents an output feature map of the convolutional block attention mechanism module; M_{c}(·) and Mₛ(·) represent channel and spatial attention functions, respectively; and ⊙ represents an element-by-element multiplication.

4. The landslide identification method based on multi-path feature fusion according to claim 1, wherein the step S4 specifically comprises:
S41, setting an iteration cycle and a maximum number of training epochs;
S42, selecting landslide images and corresponding topographic factor images from a training set, inputting the landslide images and corresponding topographic factor images into the main encoder module and the sub encoder module of the multi-path landslide identification model respectively, and outputting the identification result map through the decoder;
S43, calculating a loss function of the model comprising a weighted combination of a cross-entropy loss function and a Dice loss function, and optimizing model parameters through backpropagation and gradient descent;
S44, repeating steps S42-S43, retaining the model once upon completing one iteration cycle, inputting validation set data into the updated model, and evaluating model performance; and
S45, terminating training upon reaching a maximum number of training epochs, and selecting the model output with an optimal performance as the trained multi-path landslide identification model.

5. A storage medium, wherein the storage medium stores instructions and data for implementing the landslide identification method based on multi-path feature fusion according claim 1.

6. A computer device, wherein the computer device comprises: a processor and the storage medium; wherein the processor loads and executes the instructions and data in the storage medium to implement the landslide identification method based on multi-path feature fusion according to claim 1.
